(19) United States
(12) Patent Application Publication
(10) Pub. No.: US 2010/0125503 A1
(43) Pub. Date: May 20, 2010

(54) ASTROLOGY BASED CONTENT SELECTION

(75) Inventor: Sunil JAGADISH, Bangalore (IN)

Correspondence Address: Evergreen Valley Law Group, P.C. and Yahoo! Inc., 4 South Second Street, Suite 598, San Jose, CA, 95113, US

(73) Assignee: YAHOO! INC., Sunnyvale, CA (US)

(21) Appl. No.: 12/270,858

(22) Filed: Nov. 14, 2008

(51) Int. Cl. G06Q 30/00

(52) U.S. Cl. 705/14.54

(57) ABSTRACT

Astrology based content selection. A method includes receiving a plurality of inputs associated with a user. An astrological profile of the user is determined electronically in a computer system based on the plurality of inputs. Further, contents are selected based on the astrological profile. The contents are then provided to the user.

### BACKGROUND

Various applications, for example web advertising, include selecting contents and displaying the contents to a user. However, the problem of selecting contents, for example advertisements, that might interest the user still exists. An existing technique includes selecting contents based on various factors. The factors may include demography, geography, user usage history, user specific behavior or interest. However, the contents selected based on such factors still lack in one or more aspect as the factors may not always give the contents that interest the user. For example, a user previously interested in digital cameras may be shown advertisements related to digital cameras based on user usage history while the user may not be currently interested in the digital cameras. A user located in China may be shown advertisements related to travel in China based on the geography while the user may be interested in traveling to place other than China. A user may frequently visit websites related to football but may not be interested in products related to football. Further, in cases where the user visits a website or uses an application for a first time no usage history is available and hence, selection of contents that might interest the user is difficult.

In light of the foregoing discussion, there is a need for an efficient technique for content selection.

### SUMMARY

Embodiments of the present disclosure described herein provide a method, system and machine-readable medium for astrology based content selection.

An example of a method for advertising includes receiving a plurality of inputs associated with a user. An astrological profile of the user is determined electronically in a computer system based on the plurality of inputs. Further, one or more advertisements are selected based on the astrological profile. One or more advertisements are then provided to the user.

An example of a method includes receiving a plurality of inputs associated with a user. An astrological profile of the user is determined electronically in a computer system based on the plurality of inputs. Further, contents based on the astrological profile are selected. The contents are associated with an application running on a device of the user. The contents are then provided to the user.

An example of a method includes obtaining personal data associated to a prospective customer. The personal data includes date of birth and place of birth of the prospective customer. Further, the astrological profile for the prospective customer from the personal data is casted. Merchandise according to the astrological profile are selected and offered to the prospective customer.

An example of a system includes a communication interface in electronic communication with a network. The system also includes a memory for storing instructions. Further, the system includes an advertisement storage device for storing advertisements. A processor is used to perform astrology based content selection. The processor includes an astrological processing unit responsive to the instructions to determine astrological profile of a user. The processor also includes a content processing unit responsive to the instructions to select contents based on the astrological profile.

An example of a machine-readable medium for advertising includes instructions operable to cause a processor to perform receiving a plurality of inputs associated with a user. An astrological profile of the user is determined based on the plurality of inputs. Further, one or more advertisements are selected based on the astrological profile. One or more advertisements are then provided to the user.

An example of a machine-readable medium includes instructions operable to cause a processor to perform receiving a plurality of inputs associated with a user. An astrological profile of the user is determined based on the plurality of inputs. Further, contents based on the astrological profile are selected. The contents are associated with an application running on a device of the user. The contents are then provided to the user.

### BRIEF DESCRIPTION OF THE FIGURES

FIG. 1 is a block diagram of an environment in accordance with which various embodiments can be implemented;

FIG. 2 is a block diagram of a server in accordance with one embodiment;

FIG. 3 is a flowchart illustrating a method for advertising in accordance with one embodiment;

FIG. 4 is a flowchart illustrating a method for content selection in accordance with one embodiment; and

FIG. 5 is a flowchart illustrating a method for selling merchandise in accordance with one embodiment.

### DETAILED DESCRIPTION OF THE EMBODIMENTS

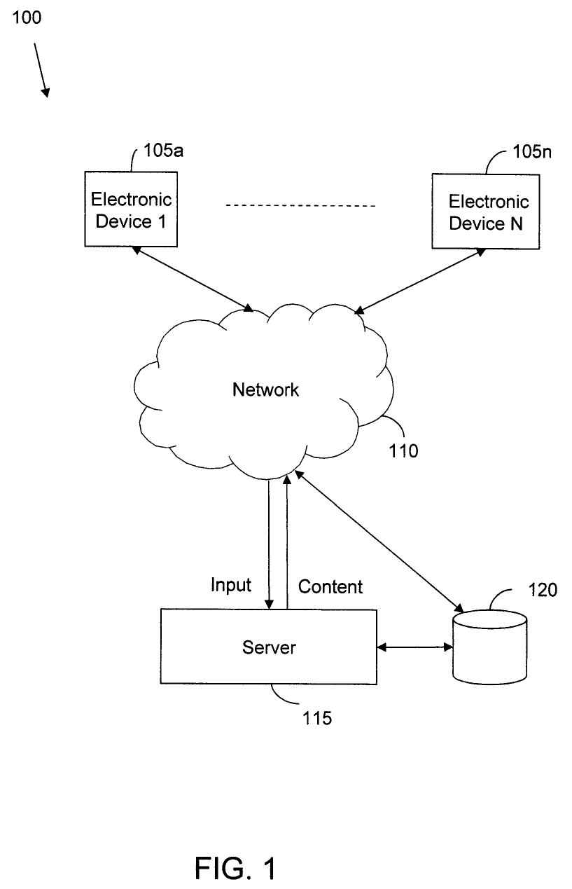

FIG. 1 is a block diagram of an environment 100 in accordance with which various embodiments can be implemented. The environment 100 includes one or more electronic devices, for example, an electronic device 105a and an electronic device 105n, connected to each other through a network 110. Examples of the electronic devices include but are not limited to computers, laptops, mobile devices, hand held devices, internet protocol televisions, and personal digital assistants (PDAs). Examples of the network 110 include but are not limited to a Local Area Network (LAN), a Wireless Local Area Network (WLAN), a Wide Area Network (WAN), internet and a Small Area Network (SAN). The electronic devices are also connected to a server 115 through the network 110. The server 115 is connected to a storage device 120.

A user of the electronic device 105a accesses an application, for example a website or Yahoo!® Messenger. A plurality of inputs including date of birth and place of birth of the user are received by the server 115. The inputs can be communicated to the server 115 through the network 110 by the electronic device 105a in response to the user inputting the inputs. In some embodiments, the plurality of inputs can be fetched from the one or more data sources, for example the application with which the user is registered.

The server 115 determines an astrological profile of the user based on the plurality of inputs. The server 115 then selects contents based on the astrological profile from the storage device 120 and provides the contents to the user through the electronic device 105a.

The storage device 120 stores the contents. The storage device 120 can also be in communication to the electronic devices through the network 110.

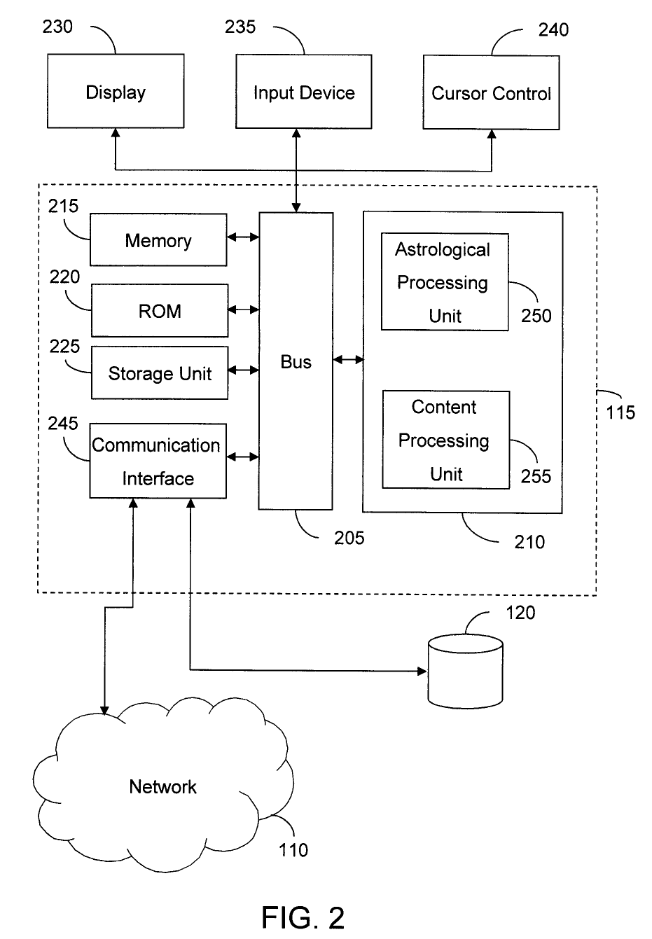

The server 115 includes a plurality of elements for performing astrology based content selection. The server 115 including the elements is explained in detail in FIG. 2.

FIG. 2 is a block diagram of the server 115 in accordance with one embodiment. The server 115 includes a bus 205 or other communication mechanism for communicating information, and a processor 210 coupled with the bus 205 for processing information. The server 115 also includes a memory 215, such as a random access memory (RAM) or other dynamic storage device, coupled to the bus 205 for storing information and instructions to be executed by the processor 210. The memory 215 can be used for storing temporary variables or other intermediate information during execution of instructions to be executed by the processor 210. The server 115 further includes a read only memory (ROM) 220 or other static storage device coupled to the bus 205 for storing static information and instructions for the processor 210. A storage unit 225, such as a magnetic disk or optical disk, is provided and coupled to the bus 205 for storing information and instructions.

The server 115 can be coupled via the bus 205 to a display 230, such as a cathode ray tube (CRT), liquid crystal display (LCD) for displaying information to a user. An input device 235, including alphanumeric and other keys, is coupled to the bus 205 for communicating information and command selections to the processor 210. Another type of user input device is a cursor control 240, such as a mouse, a trackball, or cursor direction keys for communicating direction information and command selections to the processor 210 and for controlling cursor movement on the display 230.

Various embodiments are related to the use of the server 115 for implementing the techniques described herein. In one embodiment, the techniques are performed by the server 115 in response to the processor 210 executing instructions included in the memory 225. Such instructions can be read into the memory 215 from another machine-readable medium, such as the storage unit 225. Execution of the instructions included in the memory 215 causes the processor 210 to perform the process steps described herein.

The term “machine-readable medium” as used herein refers to any medium that participates in providing data that causes a machine to operate in a specific fashion. In an embodiment implemented using the server 115, various machine-readable medium are involved, for example, in providing instructions to the processor 210 for execution. The machine-readable medium can be a storage media. Storage media includes both non-volatile media and volatile media. Non-volatile media includes, for example, optical or magnetic disks, such as the storage unit 225. Volatile media includes dynamic memory, such as the memory 215. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that include the bus 205. Transmission media can also take the form of acoustic or light waves, such as those generated during radio-wave and infra-red data communications. Examples of machine-readable medium may include but are not limited to a carrier wave as describer hereinafter or any other medium from which the server 115 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 115 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by memory 215 can optionally be stored on the storage unit 225 either before or after execution by the processor 210. All such media must be tangible to enable the instructions carried by the media to be detected by a physical mechanism that reads the instructions into a machine.

The server 115 also includes a communication interface 245 coupled to the bus 205. The communication interface 245 provides a two-way data communication coupling to network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 115 can receive the plurality of inputs through the communication interface 245. The inputs are processed by the processor 210 using one or more processing units. The processing units may be incorporated within the processor 210 or may be stand-alone that communicate with the processor 210. An astrological processing unit 250 determines an astrological profile of a user of an electronic device. The electronic device can be connected to the server 115 through the network 110. A content processing unit 255 selects contents based on the astrological profile. The astrological processing unit 250 and the content processing unit 255 include hardware circuitry performing the functions in response to the instructions. The contents can then be retrieved from the storage device 120 and provided to the user of the electronic device. In some embodiments, the contents can be fetched from various electronic devices connected to the network 110.

In another embodiment, the server 115 may not include the processing units and the functions of the processing units can be performed by the processor 210 in response to the instructions.

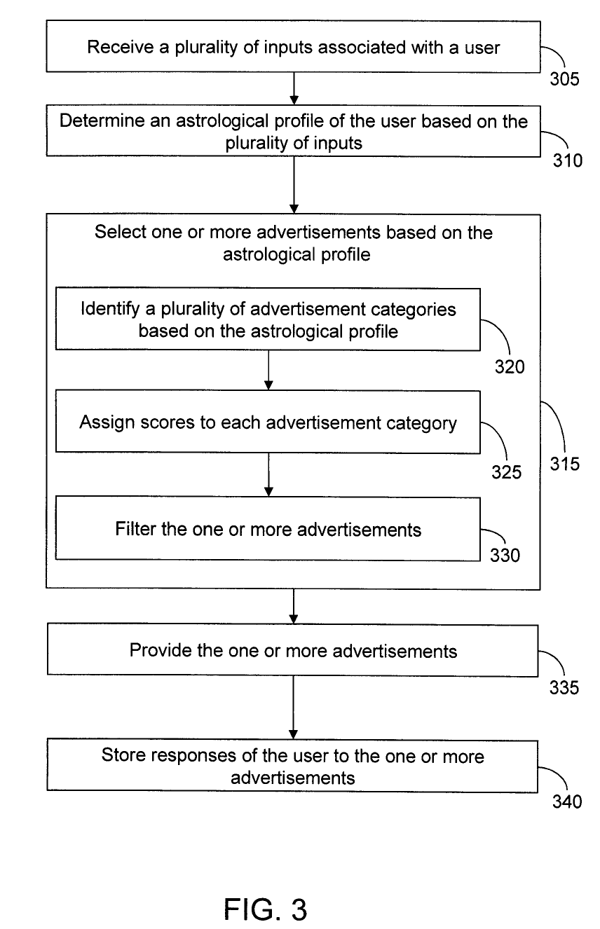

FIG. 3 is a flowchart illustrating a method for advertising in accordance with one embodiment.

At step 305, a plurality of inputs associated with a user is received. The inputs can be inputted by the user through an electronic device and can then be transmitted. In some embodiments, the inputs stored in the one or more data sources can be fetched. For example, the user can be registered with Yahoo!® mail. The information can be fetched from the Yahoo!® server based on access rights defined by the user. The information can also be fetched from a storage device. Examples of the data sources include but are not limited to a remote database server, any source of data from a specific organization such as a database or a data file, hosts, web portals, web servers, partner devices, browser cookies and social networking sites.

The inputs include date of birth and place of birth of the user. The inputs can also include one or more of name of the user, time of birth of the user, horoscope of the user, family name of the user, birth name of the user, present location of the user, time at the present location of the user, application used by a user, details of the application, browsing details, details from browser cookie and type of belief system. Examples of the application include but are limited to emails, job applications, messenger, chat applications, social networking applications, stock applications, web services, and any other application which can be accessed through the electronic device.

A belief system, for example Vedic astrology, Vedic vaastu shastra, and Feng Shui, is a set of percepts on which an individual lives a daily life, and which governs the thoughts, words, and actions of the individual. The belief system can be categorized based on religion and location, for example Indian vaastu shastra and Chinese Feng Shui.

At step 310, an astrological profile of the user is determined based on the inputs.

The astrological profile includes zodiac sign of the user. The astrological profile can also include birth number of the user. The birth number is determined using year, month and day of birth. Further, the astrological profile can include planetary information for the user, preferred color of the user, and mood of the user. The strong planets can be determined from the zodiac sign. The mood of the user can be predicted based on one or more of the zodiac sign, and user activities. The user activities can be tracked by the application or service provider of the application, and used for predicting the mood. Examples of the user activities include but are not limited to smileys, typos, search queries and other text inputs from the user. The user activities can be tracked based on access rights provided by the user.

At step 315, one or more advertisements are selected based on the astrological profile. Step 315 includes step 320, step 325 and step 330.

At step 320, a plurality of advertisement categories are identified based on the astrological profile. The advertisement categories are associated with the planets obtained from the astrological profile. The astrological profile can be matched for a particular advertisement category based on the categories associated with strong planets of the user. For example, an advertisement category, travel, can be based on the position of planets Sun, Mars and Jupiter in accordance with the astrological profile. Other examples of categories include but are not limited to health, entertainment, stocks, jobs, finance and any other category.

The advertisement categories can also be based on the, zodiac sign and the birth number.

Common patterns can be identified which determine significance of planets or zodiac sign for a particular category. The common patterns vary based on geographical location. For example, common patterns in China are based on year and animals. Another example include common patterns in India based on planets.

At step 325, scores are assigned to each advertisement category based on the astrological profile and user usage history. The score for each advertisement category is computed by adding a plurality of parameters. The parameters includes the weight based on users zodiac sign, weight of users strong planets, average score of various users of same demography, average score of users friends and initialization constant.

The scores of each advertisement category are stored in a weight matrix. The weight matrix is used to determine advertisements specific to the user. The weight matrix can be stored in a storage device. The weight matrix can be stored for each user.

At step 330, the one or more advertisements are filtered. The filtering can include assigning low priority to the advertisements which have been displayed a predefined number of times. The filtering can also be performed based on a service level agreement.

At step 335, the one or more advertisements are provided to the user. The advertisements are sent from the server to the electronic device. The user can then view the advertisements on the electronic device in the application the user is using. The user can then respond by clicking on the displayed advertisements based on personal interest.

At step 340, the responses of the user to the one or more advertisements are tracked and stored.

The responses can then be used along with the astrological profile to select advertisements for subsequent display.

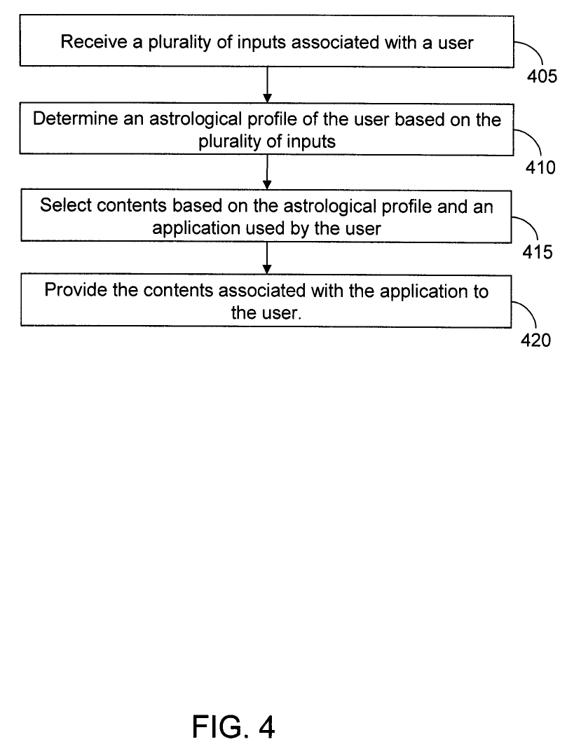

FIG. 4 is a flowchart illustrating a method for content selection in accordance with one embodiment.

At step 405, a plurality of inputs associated with a user of an application is received. The inputs can be fetched from one or more data sources. The inputs include date of birth of the user, place of birth of the user and details of the application which the user is using. Examples of the application include but are not limited to emails, job applications, messenger, chat applications, social networking applications, stock applications, web services, websites and any other application which can be accessed through the electronic device. The inputs can also include one or more of name of the user, time of birth of the user, horoscope of the user, family name of the user, birth name of the user, present location of the user, time at the present location of the user, browsing details, details from browser cookie and type of belief system.

At step 410, an astrological profile of the user is determined based on the plurality of inputs.

The astrological profile includes one or more of a zodiac sign of the user, birth number of the user, one or more planets associated with the user based on the zodiac sign, preferred color of the user and mood of the user.

At step 415, contents are selected based on the astrological profile and the application. The selection includes prioritizing the contents. The contents selection can also be based on various factors, for example user history.

At step 420, the contents associated with the application are provided to the user. The contents can be provided to the user by displaying the contents in the application running on the electronic device of the user.

The method described in FIG. 4 is explained in details in conjunction with following examples.

### EXAMPLE 1

A user is using Yahoo!® messenger on an electronic device. The user visits the chat room. The participants in the chat room can be selected based on an astrological profile of the user and displayed. The chat rooms can also be displayed selectively based on the astrological profile of the user.

### EXAMPLE 2

A user is using a stock application or website. A list of stocks or mutual funds based on an astrological profile of the user can be selected and displayed.

### EXAMPLE 3

A user is using a website, for example a dating website, a shopping website, a movie website and a job website. The contents specific to each website can be selected based on an astrological profile of the user and are displayed. For example, Canon camera can be displayed to the user based on compatibility between the user and Canon based on the astrological profile of the user.

It will be appreciated that the method can be used in recommendation based applications. For example, recommending a person for a job based on the astrological profile of the user.

Various embodiments provide astrology based content selection. The astrology based content selection increases relevance of the content as the content is selected based on personalities and character traits of a user.

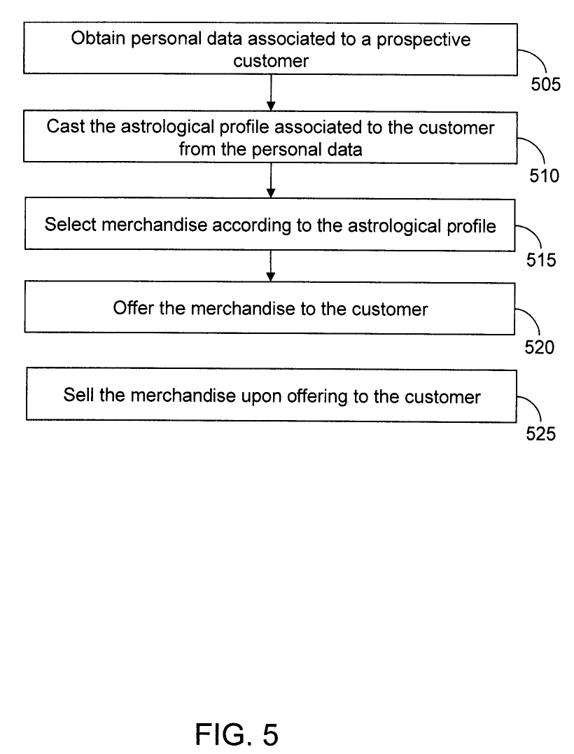

FIG. 5 is a flowchart illustrating a method for selling merchandise in accordance with one embodiment.

At step 505, personal data associated to a prospective customer is obtained. The personal data includes the customer's date of birth and place of birth.

In one embodiment, the personal data may include but is not limited to the customer's name, hour and minute of birth, astrological belief system, present location and time at the present location.

At step 510, the astrological profile associated to the customer from the personal data is casted.

At step 515, merchandise according to the astrological profile is selected.

Merchandise includes any commodities offered for sale. Examples include but are not limited to cars, textiles, appliances and commercial articles.

At step 520, the merchandise is offered to the customer.

In some embodiments, at step 525, the merchandise upon offering is sold to the customer based on customer response to the offering. The customer can chose to buy the merchandise based on interest.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A computer-implemented method for advertising, the computer-implemented method comprising:
receiving a plurality of inputs associated with a user;
determining, electronically in a computer system, an astrological profile of the user based on the plurality of inputs;
selecting one or more advertisements based on the astrological profile; and
providing the one or more advertisements to the user.

2. The computer-implemented method of claim 1, wherein the receiving comprises:
fetching the plurality of inputs stored in one or more data sources.

3. The computer-implemented method of claim 1, wherein the plurality of inputs comprise date of birth and place of birth.

4. The computer-implemented method of claim 3, wherein the plurality of inputs further comprise one or more of name, time of birth, horoscope, family name, birth name, present location, time at the present location, application used by a user, details of the application, browsing details, details from browser cookie, and type of belief system.

5. The computer-implemented method of claim 1, wherein the astrological profile comprises at least one of:
zodiac sign of the user;
birth number of the user;
one or more planets associated with the user;
preferred color of the user; and
mood of the user.

6. The computer-implemented method of claim 1, wherein the selecting comprises:
identifying a plurality of advertisement categories based on the astrological profile; and
assigning scores to each advertisement category of the plurality of advertisement categories based on the astrological profile and user usage history.

7. The computer-implemented method of claim 6, wherein the selecting further comprises:
filtering the one or more advertisements.

8. The computer-implemented method of claim 1, wherein the providing comprises:
displaying the one or more advertisements.

9. The computer-implemented method of claim 1 further comprising:
storing responses of the user to the one or more advertisements.

10. A computer-implemented method comprising;
receiving a plurality of inputs associated with a user;
determining, electronically in a computer system, an astrological profile of the user based on the plurality of inputs;
selecting contents based on the astrological profile, wherein the contents are associated with an application running on a device of the user; and
providing the contents associated with the application to the user.

11. The computer-implemented method of claim 10, wherein the selecting comprises:
prioritizing the contents.

12. A method for selling merchandise, the method comprising:
obtaining personal data associated to a prospective customer, the personal data comprising date of birth and place of birth of the prospective customer;
casting an astrological profile for the prospective customer from the personal data;
selecting merchandise according to the astrological profile; and
offering the merchandise to the prospective customer based on the selecting.

13. A system comprising:
a communication interface in electronic communication with a network;
a memory for storing instructions;
an advertisement storage device for storing advertisements; and
a processor for performing astrology based content selection, the processor comprising:
an astrological processing unit responsive to the instructions to determine astrological profile of a user; and
a content processing unit responsive to the instructions to select contents based on the astrological profile.

14. A system comprising:
a communication interface in electronic communication with a network;
a memory for storing instructions;
an advertisement storage device for storing advertisements; and
a processor for performing astrology based content selection in response to the instructions.

15. A machine-readable medium for advertising, the machine-readable medium comprising instructions operable to cause a processor to perform:
receiving a plurality of inputs associated with a user;
determining an astrological profile of the user based on the plurality of inputs;
selecting one or more advertisements based on the astrological profile; and
providing the one or more advertisements to the user.

16. The machine-readable medium of claim 15, wherein the receiving comprises:
fetching the plurality of inputs stored in one or more data sources.

17. The machine-readable medium of claim 15, wherein the plurality of inputs comprise date of birth and place of birth.

18. The machine-readable medium of claim 17, wherein the plurality of inputs further comprise one or more of name, time of birth, horoscope, family name, birth name, zodiac sign, present time, present location, application used by a user, details of the application, browsing details, details from browser cookie, and type of belief system.

19. The machine-readable medium of claim 15, wherein the astrological profile comprises at least one of:
zodiac sign of the user;
birth number of the user;
one or more planets associated with the user;
preferred color of the user; and
mood of the user.

20. The machine-readable medium of claim 15, wherein the selecting comprises:
identifying a plurality of advertisement categories based on the astrological profile; and
assigning scores to each advertisement category of the plurality of advertisement categories based on the astrological profile and user usage history.

21. The machine-readable medium of claim 20, wherein the selecting further comprises:
filtering the one or more advertisements.

22. The machine-readable medium of claim 15, wherein the providing comprises:
displaying the one or more advertisements.

23. The machine-readable medium of claim 15 further comprising:
storing response of the user to the one or more advertisements.

24. A machine-readable medium comprising instructions operable to cause a processor to perform:
receiving a plurality of inputs associated with a user;
determining, electronically in a computer system, an astrological profile of the user based on the plurality of inputs;
selecting contents based on the astrological profile, wherein the contents are associated with an application running on a device of the user; and
providing the contents associated with the application to the user.

25. The machine-readable medium of claim 24, wherein the selecting comprises:
prioritizing the contents.
